(19) United States
(12) Patent Application Publication
(10) Pub. No.: US 2019/0265847 A1
(43) Pub. Date: Aug. 29, 2019

(54) DISPLAY APPARATUS AND METHOD FOR CONTROLLING DISPLAY APPARATUS

(71) Applicant: SEIKO EPSON CORPORATION, Tokyo (JP)

(72) Inventor: Takahiro ANO, MATSUMOTO-SHI (JP)

(73) Assignee: SEIKO EPSON CORPORATION, Tokyo (JP)

(21) Appl. No.: 16/284,785

(22) Filed: Feb. 25, 2019

(30) Foreign Application Priority Data
Feb. 26, 2018 (JP) 2018-031650

(51) Int. Cl. G06F 3/0482; G06F 3/0484; G06F 3/14

(52) U.S. Cl. CPC G06F 3/0482; G06F 3/14; G06F 3/04842

(57) ABSTRACT

A projector including a plurality of input interfaces includes a communication interface, a generation section that generates a selection screen based on output interface information acquired via the communication interface section and relating to an output interface with which a terminal apparatus is provided, and a projection section that projects the selection screen, and the generation section generates the selection screen containing a same-type interface but no different-type interface different from the same-type interface.

### CROSS-REFERENCE

The entire disclosure of Japanese Patent Application No. 2018-031650, filed Feb. 26, 2018 is expressly incorporated by reference herein.

### BACKGROUND

### 1. Technical Field

The present invention relates to a display apparatus and a method for controlling the display apparatus.

### 2. Related Art

There is a known technology for displaying a selection screen that allows selection of an input section to which a video image source can be inputted, such as an input terminal (see JP-A-2011-91632, for example). JP-A-2011-91632 discloses a projector that displays a selection screen containing icons each causing a user to recall a video image source and allowing the user to select any of the icons to use the video image source corresponding to the selected icon.

In JP-A-2011-91632, however, the larger the number of input sections with which the projector is provided, the larger the number of icons contained in the selection screen. In JP-A-2011-91632, there is therefore a large number of choices when the projector is connected to an information terminal, so that the user cannot readily determine in some cases which input section should be selected.

### SUMMARY

An advantage of some aspects of the invention is to improve a user's convenience when a display apparatus is connected to an information terminal.

An aspect of the invention is directed to a display apparatus including a plurality of input sections including a first input section and a second input section different from the first input section, the display apparatus including a communication section, a generation section that generates a selection screen based on output section information acquired via the communication section and relating to an output section with which an information terminal is provided, and a display section that displays the selection screen, and the generation section generates based on the output section information the selection screen that contains the first input section but does not contain the second input section.

According to the aspect of the invention, since the selection screen that contains the first input section but does not contain the second input section is generated based on the output section information, a user can readily determine which input section should be selected when the information terminal is connected to the display apparatus, whereby the user's convenience can be improved when the information terminal is connected to the display apparatus.

In the aspect of the invention, the generation section may generate the selection screen with the first input section being any of the input sections connectable to the output section and the second input section being any of the input sections not connectable to the output section.

According to the aspect of the invention with this configuration, the selection screen is so generated that the first input section is any of the input sections connectable to the output section, with which the information terminal is provided, and the second input section is any of the input sections not connectable to the output section, with which the information terminal is provided, so that the user can readily determine which input section is the input section connectable to the information terminal, whereby the user's convenience can be improved when the information terminal is connected to the display apparatus.

In the aspect of the invention, in a case where the information terminal sets the output section indicated by the output section information based on operation detected by the information terminal and any of the input sections of the display apparatus is connectable to the output section set based on the operation, the generation section may generate the selection screen with the first input section being the input section.

According to the aspect of the invention with this configuration, in the case where the display apparatus includes an input section connectable to the set output section, the selection screen is so generated that the first input section is the input section, so that the set input section can be presented to the user, whereby the user's convenience can be improved when the information terminal is connected to the display apparatus.

In the aspect of the invention, the information terminal is provided with a plurality of the output sections, in a case where the information terminal sets the output section used at a largest frequency in the output section information and any of the input sections of display apparatus is connectable to the output section set in the output section information, the generation section may generate the selection screen with the first input section being the input section.

According to the aspect of the invention with this configuration, in the case where there is an input section connectable to the output section used at the largest frequency, the selection screen is so generated that the first input section is the input section, so that an input section connectable to the output section used at the largest frequency, whereby the user's convenience can be improved when the information terminal is connected to the display apparatus.

In the aspect of the invention, in a case where the output section information is acquired from a plurality of the information terminals via the communication section, the generation section may generate the selection screen for each of the information terminals.

According to the aspect of the invention with this configuration, since the selection screen is generated for each of the information terminals. Therefore, even in the case where there are a plurality of information terminals to be connected to the display apparatus, the user can readily determine which input section should be selected for each of the information terminals, whereby the user's convenience can be improved when the plurality of information terminals are connected to the display apparatus.

In the aspect of the invention, the communication section may acquire user information representing a user of the information terminal along with the output section information, and the generation section may generate the selection screen containing the user information.

According to the aspect of the invention with this configuration, since a selection screen containing the user information is generated, the user can readily recognize that the selection screen displayed by the display section is the selection screen associated with the information terminal being used by the user, whereby the user's convenience can be improved when the information terminal is connected to the display apparatus.

Another aspect of the invention is directed to a method for controlling a display apparatus including a plurality of input sections including a first input section and a second input section different from the first input section, the method including acquiring output section information on an output section with which an information terminal is provided, generating based on the acquired output section information a selection screen that contains the first input section but does not contain the second input section, and displaying the selection screen.

According to the aspect of the invention, since the selection screen that contains the first input section but does not contain the second input section is generated based on the output section information, the user can readily determine which input section should be selected when the information terminal is connected to the display apparatus, whereby the user's convenience can be improved when the information terminal is connected to the display apparatus.

### BRIEF DESCRIPTION OF THE DRAWINGS

The invention will be described with reference to the accompanying drawings, wherein like numbers reference like elements.

FIG. 1 shows a schematic configuration of an image projection system according to a first embodiment.

FIG. 2 shows the configuration of a projector.

FIG. 3 shows the configuration of a terminal apparatus.

FIG. 4 is flowcharts showing the actions of the projector and the terminal apparatus.

FIG. 5 shows an example of a home screen.

FIG. 6 shows an example of a selection screen.

FIG. 7 shows a schematic configuration of an image projection system according to a second embodiment.

FIG. 8 is flowcharts showing the actions of a projector and terminal apparatuses.

FIG. 9 shows an example of the selection screen.

### DESCRIPTION OF EXEMPLARY EMBODIMENTS

### First Embodiment

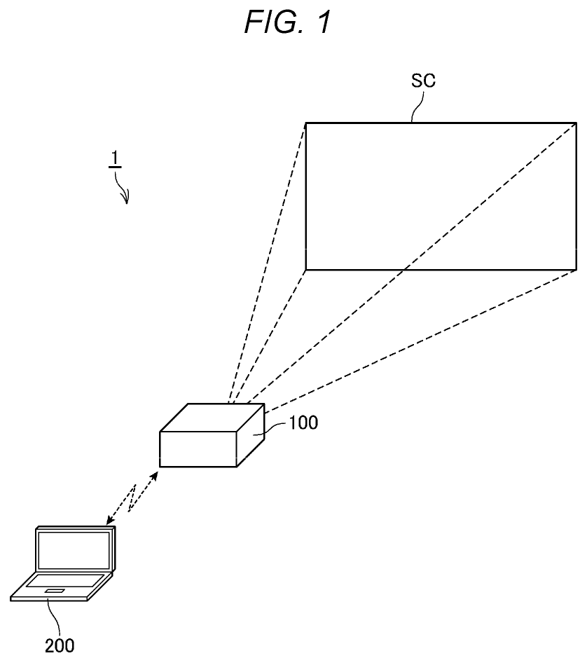

FIG. 1 shows a schematic configuration of an image projection system 1 according to a first embodiment. The image projection system 1 according to the present embodiment includes a projector 100 (display apparatus) and a terminal apparatus 200 (information terminal).

The projector 100 and the terminal apparatus 200 are so configured as to be capable of transmitting and receiving a variety of data by using a wireless communication method to carry out processes described later. Examples of the wireless communication method may include a short-range wireless communication method, such as a wireless LAN (local area network) and Bluetooth (registered trademark).

To transmit and receive at least one of a video signal and a voice signal, the projector 100 and the terminal apparatus 200 transmit and receive the signal by using a wireless communication method or a wired communication method.

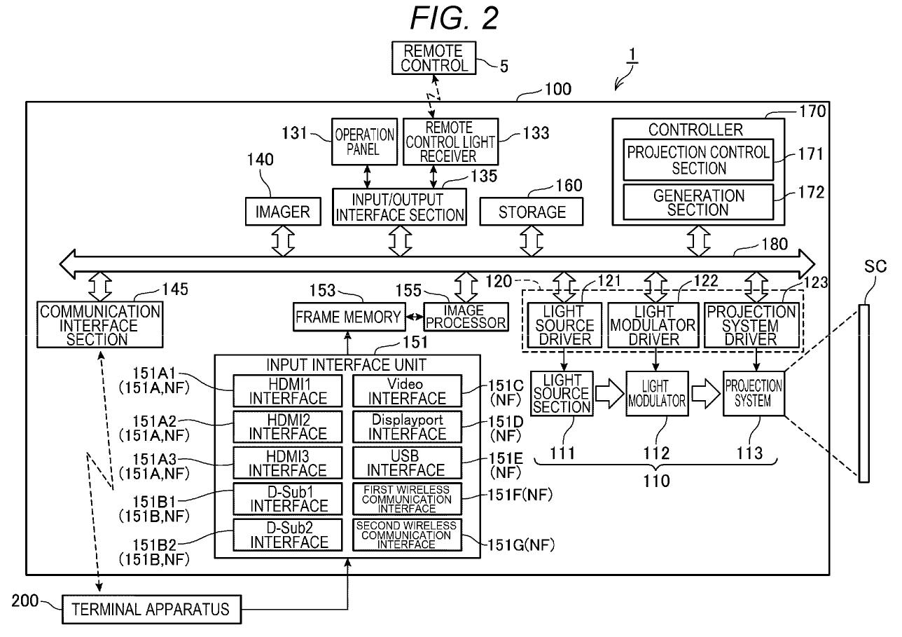

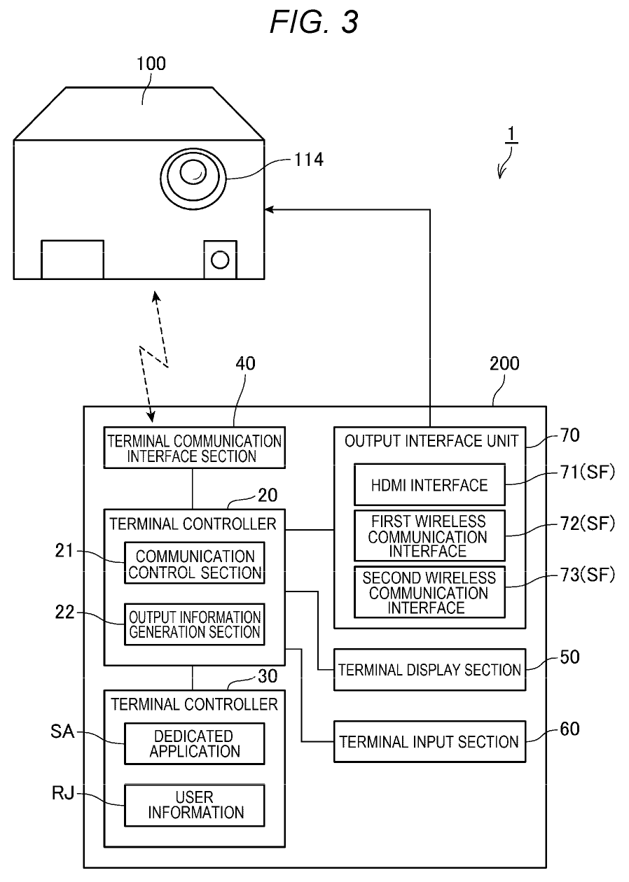

The projector 100 projects image light onto a projection target to form an image based on image data on the surface of the projection target. The projection target on which the projector 100 projects an image may be a flat surface, a curved surface, or an irregular surface. In the present embodiment, a case where the projection is performed on a screen SC formed of a flat surface is presented by way of example. The screen SC may be a fixed flat surface, such as a wall surface, or a hanging or standing curtain-shaped screen. The projector 100 is provided with a projection opening 114 (see FIG. 3), via which the image light is projected. The projection opening 114 is an opening via which a projection system 113 (see FIG. 2) built in the projector 100 outputs light.

The terminal apparatus 200 is, for example, a notebook PC (personal computer), a desktop PC, or any other apparatus. In FIG. 1, a notebook PC is presented as the terminal apparatus 200 by way of example. The terminal apparatus 200 is not limited to a personal computer and can, for example, be a tablet terminal, a smartphone, or a PDA (personal digital assistant). The terminal apparatus 200 may still instead be a video reproduction apparatus, a DVD (digital versatile disk) player, a Blu-Ray disk player, a hard disk recorder, a television tuner, a set top box of a CATV (cable television), a video game console, or any other apparatus.

FIG. 2 shows the configuration of the projector 100.

The projector 100 includes an input interface unit 151. The input interface unit 151 includes connectors and/or interface circuits (neither of them is shown) to each of which a cable is connected.

The input interface unit 151 receives a signal transmitted from the terminal apparatus 200. The input interface unit 151 extracts image data and sync signals (vertical sync signal and horizontal sync signal) contained in the received signal. The input interface unit 151 outputs the extracted image data to a frame memory 153 to cause the frame memory 153 to store the image data and outputs the sync signals to an image processor 155 and a controller 170. The image processor 155 processes the image data in synchronization with the sync signals. The controller 170 controls the action of each portion that forms the projector 100 based on the sync signals.

The input interface unit 151 can, for example, include the following interfaces.

The interfaces can be HDMI {registered trademark (High-Definition Multimedia Interface)}, Displayport, MHL (Mobile High-definition Link, registered trademark), HDBaseT (registered trademark), Thunderbolt (registered trademark), USB Type-C, 3G-SDI (Serial Digital Interface), and other interfaces capable of transmitting a video signal and a voice signal in the digital form. The interfaces may further be Ethernet (registered trademark), IEEE1394, USB, and other data communication interfaces. Further, the terminal apparatus 200 and the projector 100 may each be provided with an RCA terminal, a VGA terminal, an S terminal, a D terminal, or any other analog video terminal and may transmit and receive an analog video signal via the terminals.

The input interface unit 151 in the present embodiment includes three HDMI interfaces 151A (151A1, 151A2, and 151A3) (input sections).

The input interface unit 151 further includes two D-Sub interfaces 151B (151B1 and 151B2) (input sections).

The input interface unit 151 further includes a video interface 151C (input section).

The input interface unit 151 further includes a Displayport interface 151D (input section).

The input interface unit 151 further includes a USB interface 151E (input section).

The input interface unit 151 further includes a first wireless communication interface 151F (input section).

The input interface unit 151 further includes a second wireless communication interface 151G (input section).

In the following description, in a case where the interfaces provided in the input interface unit 151 are not distinguished from one another but are collectively called, the interfaces are referred to as input interfaces NF.

The HDMI interfaces 151A (151A1, 151A2, and 151A3) are each an interface that includes a connector, an interface circuit, and other components compliant with the HDMI standard and receives a video signal and a voice signal by using a wired communication method in accordance with the HDMI standard.

The D-Sub interfaces 151B (151B1 and 151B2) are each an interface that includes a connector, an interface circuit, and other components compliant with the D-Sub standard and receives a video signal by using a wired communication method in accordance with the D-Sub standard.

The video interface 151C is an interface that includes, for example, a component terminal as the analog video terminal and receives an analog video signal by using a wired communication method.

The Displayport interface 151D is an interface that includes a connector, an interface circuit, and other components compliant with a predetermined Displayport standard and receives a video signal and a voice signal by using a wired communication method in accordance with the Displayport standard.

The USB interface 151E is an interface that includes a connector, an interface circuit, and other components compliant with the USB standard and receives a video signal and a voice signal by using a wired communication method in accordance with the USB standard.

The first wireless communication interface 151F is an interface that receives a video signal by using a wireless communication method in accordance with a predetermined wireless communication standard and is achieved by a device driver different from the device driver that achieves the second wireless communication interface 151G.

The second wireless communication interface 151G is an interface that receives a video signal by using a wireless communication method in accordance with a predetermined wireless communication standard and is achieved by a device driver different from the device driver that achieves the first wireless communication interface 151F.

For example, in a case where the first wireless communication interface 151F operates in accordance with Miracast (registered trademark), the second wireless communication interface 151G is an interface that does not operate in accordance with Miracast.

The projector 100 includes a projection section 110 (display section), which forms an optical image and projects the optical image on the screen SC, and a driver unit 120, which drives the projection section 110. The projection section 110 includes a light source section 111, a light modulator 112, and the projection system 113. The driver unit 120 includes a light source driver 121, a light modulator driver 122, and a projection system driver 123. The projection section 110 corresponds to the “display section” in an aspect of the invention.

The light source section 111 includes a light source, such as a xenon lamp, an ultrahigh-pressure mercury lamp, an LED (light emitting diode), and a laser light source. The light source section 111 may further include a reflector and an auxiliary reflector that guide the light emitted by the light source to the light modulator 112. The light source section 111 may further include a lens group for enhancing the optical characteristics of the projection light, a polarizer, a light adjusting element that is disposed in the path leading to the light modulator 112 and attenuates the amount of the light emitted by the light source, or any other component (none of the components described above is shown).

The light source section 111 is driven by the light source driver 121. The light source driver 121 is connected to a bus 180 and turns on and off the light source in the light source section 111 under the control of the controller 170 (which will be described later) connected to the bus 180.

The light modulator 112 includes three liquid crystal panels corresponding, for example, to the RGB three primary colors. The light outputted by the light source section 111 is separated by dichroic mirrors, reflection mirrors, relay lenses, and other components (none of them is shown) into RGB three-color light fluxes, which are incident on the corresponding liquid crystal panels. The three liquid crystal panels are each a transmissive liquid crystal panel and modulate light passing therethrough to generate image light. The image light fluxes having passed through the liquid crystal panels and having therefore been modulated are combined with one another by a light combining system, such as a cross dichroic prism, and the combined light travels toward the projection system 113.

The light modulator 112 is driven by the light modulator driver 122. The light modulator driver 122 is connected to the bus 180 and drives the light modulator 112 under the control of the controller 170.

The light modulator driver 122 generates drive signals for each R, G, B color that drive the liquid crystal panels based on image data inputted from the image processor 155. The light modulator driver 122 drives, based on the generated RGB drive signals, the corresponding color liquid crystal panels to draw images on the liquid crystal panels.

The projection system 113 includes a lens group that projects the image light modulated by the light modulator 112 toward the screen SC to form an image on the screen SC. The projection system 113 may further include a zoom mechanism that enlarges or reduces an image projected on the screen SC and adjusts the focal point and a focus adjustment mechanism that adjusts focusing.

The projection system 113 is driven by the projection system driver 123. The projection system driver 123 includes, for example, motors, and drives the motors under the control of the controller 170 to adjust the zooming and focusing.

The projector 100 includes an operation section. The operation section includes an operation panel 131, a remote control light receiver 133, and an input/output interface section 135.

The operation panel 131, which functions as a user interface, is provided with a variety of operation keys and a liquid crystal panel. The input/output interface section 135 is connected to the operation panel 131, the remote control light receiver 133, and the bus 180. When any of the operation keys is operated, the input/output interface section 135 outputs an operation signal corresponding to the operated operation key to the controller 170. The input/output interface section 135 causes the liquid crystal panel to display a variety of operation screens under the control of the controller 170. A variety of buttons that allow operation of the projector 100 are displayed on the operation screens.

The remote control light receiver 133, which receives an infrared signal, receives an infrared signal transmitted from a remote control 5, which functions as a user interface. The remote control light receiver 133 decodes the received infrared signal to produce an operation signal representing the content of the operation performed on the remote control 5 and outputs the operation signal to the controller 170.

The projector 100 includes an imager 140. The imager 140 includes an imaging optical system, an imaging device, such as a CCD (charge coupled device) and a CMOS (complementary metal oxide semiconductor) device, and an interface circuit. The imaging device may be configured to be capable of measuring luminance (Y) out of the XYZ tristimulus values or may have a typical configuration that can measure each of RGB color components. The imager 140 performs imaging under the control of the controller 170 along the direction in which the projection system 113 performs projection.

The projector 100 includes a communication interface section 145 (communication section). The communication interface section 145 transmits and receives a variety of data to and from the terminal apparatus 200 in accordance with a predetermined wireless communication standard under the control of the controller 170. Examples of the predetermined wireless communication standard may include a wireless LAN and Bluetooth, as described above.

The projector 100 includes an image processing system. The image processing system is primarily formed of the controller 170, which integrally controls the entire projector 100, and further includes the frame memory 153, the image processor 155, and a storage 160. The controller 170, the image processor 155, and the storage 160 are connected to each other via the bus 180 in a communicable manner.

The frame memory 153 has a plurality of banks. The banks each have storage capacity that allows one frame of image data to be written. The frame memory 153 is formed, for example, of an SDRAM (synchronous dynamic random access memory). An SDRAM is a DRAM that reads and writes data in synchronization with a clock.

The image processor 155 performs a resolution conversion (scaling) process or a resizing process, a distortion correction process, a shape correction process, a digital zoom process, adjustment of the color tone and brightness of an image, and other processes on the image data developed in the frame memory 153. The image processor 155 carries out a process specified by the controller 170 and carries out the process as necessary using a parameter inputted from the controller 170. The image processor 155 can, of course, carry out a plurality of the processes described above in combination.

The image processor 155 reads processed image data from the frame memory 153 and outputs the image data to the light modulator driver 122.

The storage 160 is an auxiliary storage device, for example, a hard disk drive. The storage 160 may be replaced, for example, with a semiconductor memory, such as a flash memory and an EEPROM (Electrically Erasable Programmable ROM), or an optical disk, such as a CD (compact disc), a DVD (digital versatile disc), and a BD (Blu-ray (registered trademark) disc). The storage 160 stores a control program executed by the controller 170 and a variety of data, such as parameters used in the image processing performed by the image processor 155. The storage 160 further stores image data. The projector 100 reads the image data from the storage 160, performs image processing on the image data, and projects the processed imaged data on the screen SC via the projection section 110.

The controller 170 includes a CPU, a ROM, a RAM, and other peripheral circuits (none of them is shown) as hardware. The CPU is a processor that performs computation and performs the computation in accordance with the control program stored in the ROM or the storage 160. The ROM is a nonvolatile memory and stores, for example, the control program and computation data. The RAM is used as a work area that temporarily stores the control program executed by the processor and the computation data used by the processor.

In the present embodiment, the controller 170 includes a single processor (CPU), and the processor carries out processes according to the control program to achieve the functions of the controller 170. A plurality of processors or semiconductor chips may instead achieve the functions of the controller 170. For example, the controller 170 may further include a co-processor, such as a System-on-a-Chip (SoC), a micro control unit (MCU), and a field-programmable gate array (FPGA). The controller 170 may cause the CPU and the co-processor to cooperate with each other or may selectively use one of the CPU and the co-processor to perform a variety of types of control.

The controller 170 includes a projection control section 171 and a generation section 172 as functional blocks. The functional blocks represent for convenience the functions achieved when the CPU performs computation in accordance with the control program in the form of blocks but do not each stand for specific application software or hardware.

The projection control section 171 controls the image processor 155 and the driver unit 120 to cause them to project an image on the screen SC. Specifically, the projection control section 171 controls the image processor 155 to cause the image processor 155 to process the image data developed in the frame memory 153. In this process, the projection control section 171 reads a parameter necessary for the image processor 155 to process the image data from the storage 160 and outputs the parameter to the image processor 155.

The projection control section 171 further controls the light source driver 121 to cause it to turn on the light source of the light source section 111 and adjust the luminance of the light from the turned-on light source. The projection control section 171 still further controls the light modulator driver 122 to cause the liquid crystal panels of the light modulator 112 to draw images. The projection control section 171 further controls the projection system driver 123 to cause it to drive the motors to adjust the amount of zooming and focusing performed by the projection system 113.

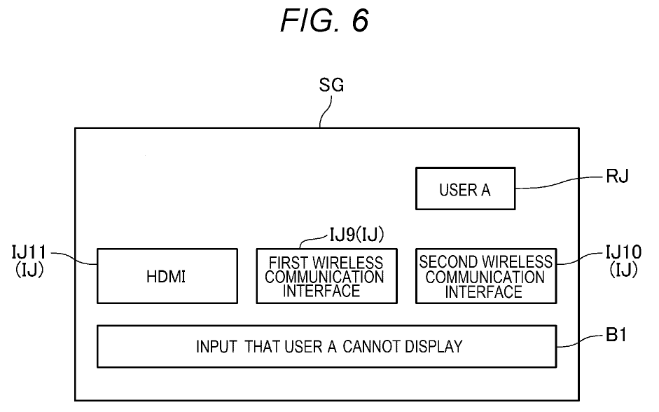

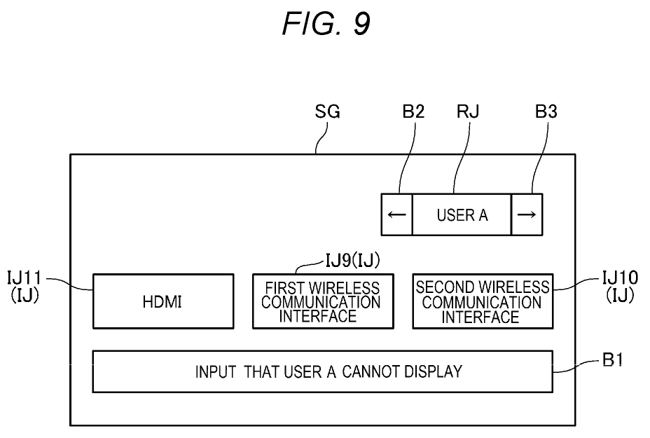

The generation section 172 generates image data representing a selection screen SG (see FIGS. 6 and 9). The selection screen SG will be described later in detail. Generating the image data representing the selection screen SG corresponds to generating the selection screen SG. The generation section 172 outputs the generated image data representing the selection screen SG to the projection control section 171. The projection control section 171 then controls the image processor 155 and the driver unit 120 to cause them to project the selection screen SG.

FIG. 3 shows the configuration of the terminal apparatus 200.

The terminal apparatus 200 includes a terminal controller 20, which controls each portion of the terminal apparatus 200. The terminal controller 20 includes a CPU, a ROM, a RAM, and other peripheral circuits (none of them is shown) as hardware. The CPU is a processor that performs computation and performs the computation in accordance with a control program stored in the ROM or a terminal storage 30. The ROM is a nonvolatile memory and stores, for example, the control program and computation data. The RAM is used as a work area that temporarily stores the control program executed by the processor and the computation data used by the processor.

The terminal controller 20 includes a communication control section 21 and an output information generation section 22 as functional blocks. The functional blocks represent for convenience the functions achieved when the CPU performs computation in accordance with the control program in the form of blocks but do not each stand for specific application software or hardware. The communication control section 21 and the output information generation section 22 will be described later.

The terminal apparatus 200 includes the terminal storage 30. The terminal storage 30 is formed of a nonvolatile storage device, such as a flash memory and an EEPROM, and stores a variety of data in a nonvolatile manner. The terminal storage further stores a dedicated application program SA (hereinafter referred to as “dedicated application SA”). The dedicated application SA is an application program so executed by the CPU as to cause the terminal controller 20 to function as the communication control section 21 and the output information generation section 22 based on cooperation between software and hardware. The terminal storage 30 further stores user information RJ. The user information RJ is identification information for identifying a user who uses the terminal apparatus 200. For example, in a case where the terminal apparatus 200 is owned by a company, an example of the user information RJ may be employee numbers assigned to employees who belong to the company. Another example of the user information RJ may be the name of an owner who owns the terminal apparatus 200. In a case where a user ID needs to be inputted to activate the dedicated application SA, the user information RJ may, for example, be the user ID.

The terminal apparatus 200 includes a terminal communication interface section 40. The terminal communication interface section 40 is controlled by the terminal controller 20 and transmits and receives a variety of data to and from the projector 100 in accordance with the wireless communication method described above.

The terminal apparatus 200 includes a terminal display section 50. The terminal display section 50 includes a display panel and displays a variety of pieces of information on the display panel under the control of the terminal controller 20.

The terminal apparatus 200 includes a terminal input section 60. The terminal input section 60 includes an input device, such as a keyboard and a mouse, detects the user's operation performed on the input device, generates operation information based on the operation, and outputs the operation information to the terminal controller 20. The terminal controller 20 carries out a process corresponding to the user's operation performed on the input device based on the operation information from the terminal input section 60.

The terminal apparatus 200 includes an output interface unit 70. The output interface unit 70 includes connectors and/or interface circuits (none of them is shown) to each of which a cable is connected. The output interface unit 70 transmits a signal to the projector 100.

The output interface unit 70 can include, for example, the same interfaces as those of the input interface unit 151 described above. The output interface unit 70 in the present embodiment includes an HDMI interface 71 (output section), a first wireless communication interface 72 (output section), and a second wireless communication interface 73 (output section).

In the following description, in a case where the interfaces provided in the output interface unit 70 are not distinguished from one another but are collectively called, the interfaces are referred to as output interfaces SF.

The HDMI interface 71 is an interface of the same type as the type of the HDMI interfaces 151A and includes a connector, an interface circuit, and other components compliant with the HDMI standard. The HDMI interface 71 transmits a video signal and a voice signal by using a wired communication method in accordance with the HDMI standard.

The first wireless communication interface 72 is an interface having the same type as the type of the first wireless communication interface 151F and achieved by a device driver different from the device driver that achieves the second wireless communication interface 73. The first wireless communication interface 72 transmits a video signal by using a wireless communication method in accordance with a predetermined wireless communication standard.

The second wireless communication interface 73 is an interface having the same type as the type of the second wireless communication interface 151G and achieved by a device driver different from the device driver that achieves the first wireless communication interface 72. The second wireless communication interface 73 transmits a video signal by using a wireless communication method in accordance with a predetermined wireless communication standard.

For example, in a case where the first wireless communication interface 72 operates in accordance with Miracast, the second wireless communication interface 73 is an interface that does not operate in accordance with Miracast.

The communication control section 21 and the output information generation section 22, which are provided in the terminal controller 20, will next be described.

The communication control section 21 controls the terminal communication interface section 40 to wirelessly communicate with the projector 100. To start the communication with the projector 100, the communication control section 21 carries out a predetermined process of establishing the connection with the communication interface section 145 provided in the projector 100. The communication control section 21 transmits output interface information (output section information) generated by the output information generation section 22 to the projector 100. The communication control section 21, when it transmits the output interface information to the projector 100, also transmits the user information RJ stored by the terminal storage 30.

The output information generation section 22 generates the output interface information. The output interface information is information on the output interfaces SF, with which the terminal apparatus 200 is provided. The output information generation section 22 generates, as the information on the output interfaces SF, information representing the output interfaces SF, such as information representing the types of the output interfaces SF.

The actions of the projector 100 and the terminal apparatus 200 will next be described.

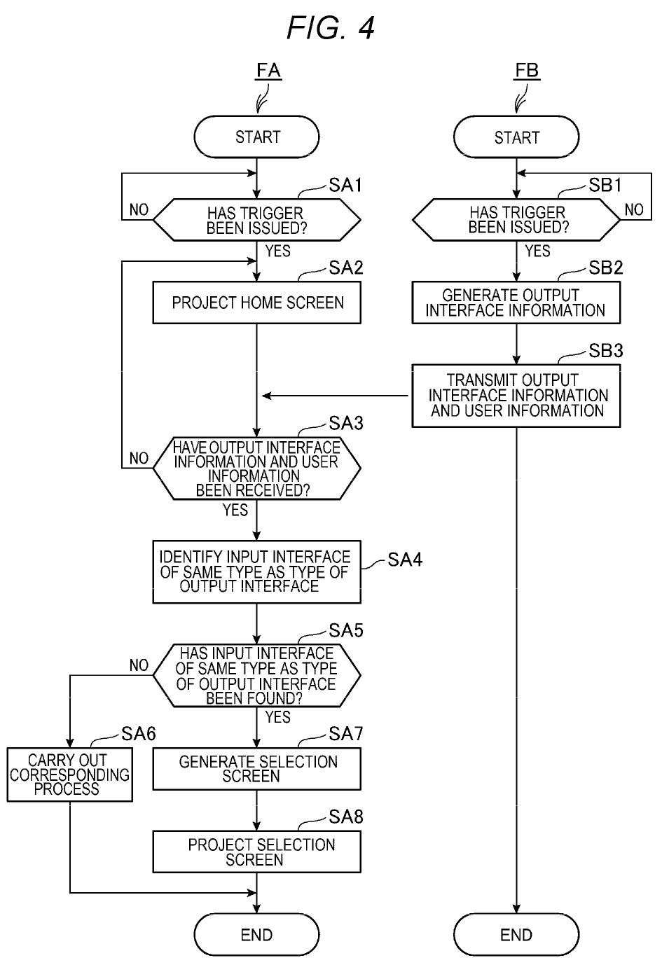

FIG. 4 is flowcharts showing the actions of the projector 100 and the terminal apparatus 200. In FIG. 4, the flowchart FA shows the action of the projector 100. In FIG. 4, the flowchart FB shows the action of the terminal apparatus 200.

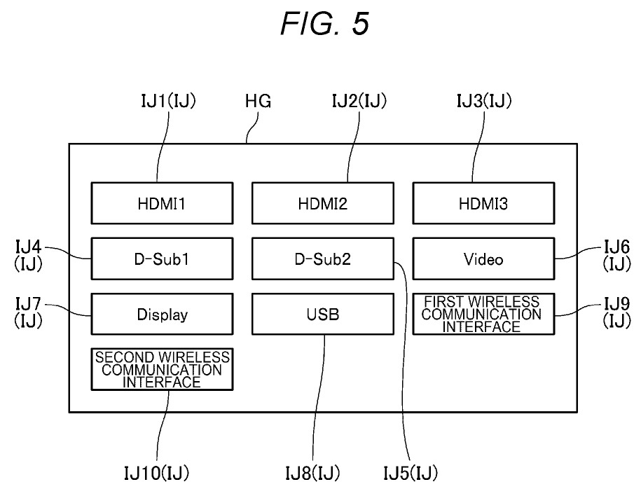

The projection control section 171 of the controller 170 of the projector 100 evaluates whether or not a trigger in response to which a home screen HG (see FIG. 5) is projected has been issued (step SA1), as shown in the flowchart FA in FIG. 4. The home screen HG will be described later. For example, when the projector 100 is powered on, the projection control section 171 determines that the trigger in response to which the home screen HG is projected has been issued (YES in step SA1). Further, for example, when the action mode of the projector 100 transitions from a power saving mode to a normal mode in which the light source is turned on, the projection control section 171 determines that the trigger in response to which the home screen HG is projected has been issued (YES in step SA1).

The projection control section 171, when it determines that the trigger in response to which the home screen HG is projected has been issued (YES in step SA1), controls the image processor 155 and the driver unit 120 to cause them to project the home screen HG on the screen SC (step SA2).

FIG. 5 shows an example of the home screen HG.

The home screen HG contains interface information IJ representing all the input interfaces NF provided in the input interface unit 151, as shown in FIG. 5. That is, the home screen HG contains interface information IJ1 representing the HDMI1 interface 151A1, interface information IJ2 representing the HDMI2 interface 151A2, interface information IJ3 representing the HDMI3 interface 151A3, interface information IJ4 representing the D-Sub1 interface 151B1, interface information IJ5 representing the D-Sub2 interface 151B2, interface information IJ6 representing the video interface 151C, interface information IJ7 representing the Displayport interface 151D, interface information IJ8 representing the USB interface 151E, interface information IJ9 representing the first wireless communication interface 151F, and interface information IJ10 representing the second wireless communication interface 151G. In the present embodiment, it is assumed that the situation in which the home screen HG contains information (including interface information IJ) means the situation in which the home screen HG displays information.

The pieces of interface information IJ are each contained in the home screen HG selectively by operation performed, for example, on the remote control 5 and the operation panel 131. When any one of the pieces of interface information IJ is selected on the home screen HG, the projection control section 171 sets the input interface NF to which at least a video signal is input from the terminal apparatus 200 to be the input interface NF indicated by the selected interface information IJ.

The home screen HG shown in FIG. 5 contains only the interface information IJ and may further contain other pieces of information.

Referring back to the description with reference to FIG. 4, the communication control section 21 of the terminal controller 20 of the terminal apparatus 200 evaluates whether or not a trigger in response to which the output interface information is transmitted has been issued (step SB1). For example, when the dedicated application SA is activated, the communication control section 21 determines that the trigger in response to which the output interface information is transmitted has been issued (YES in step SB1). Further, for example, when a predetermined period has elapsed, the communication control section 21 determines that the trigger in response to which the output interface information is transmitted has been issued (YES in step SB1).

In the case where the communication control section 21 determines that the trigger in response to which the output interface information is transmitted has been issued (YES in step SB1), the output information generation section 22 generates the output interface information (step SB2). In the present embodiment, the output interfaces SF include the HDMI interface 71, the first wireless communication interface 72, and the second wireless communication interface 73. The output information generation section 22 therefore generates, as the information on the output interfaces SF, output interface information at least including information representing the HDMI interface 71, the first wireless communication interface 72, and the second wireless communication interface 73.

Thereafter, once the output information generation section 22 generates the output interface information, the communication control section 21 then controls the terminal communication interface section 40 to transmit the output interface information generated by the output information generation section 22 and the user information RJ stored in the terminal storage 30 (step SB3).

The generation section 172 of the controller 170 of the projector 100 evaluates whether or not the communication interface section 145 has received the output interface information and the user information RJ from the terminal apparatus 200 (step SA3), as shown in the flowchart FA in FIG. 4. The situation in which the projector 100 receives the output interface information and the user information RJ corresponds to the situation in which the projector 100 acquires the output interface information and the user information RJ.

In a case where the generation section 172 determines that it has not received the output interface information or the user information RJ from the terminal apparatus 200 (NO in step SA3), the projection control section 171 keeps projecting the home screen HG.

On the other hand, in a case where the generation section 172 determines that it has received the output interface information and the user information RJ from the terminal apparatus 200 (YES in step SA3), the generation section 172 identifies, from the input interface unit 151, the input interface NF of the same type as the type of the output interface SF indicated by the output interface information (step SA4). The input interface NF of the same type as the type of the output interface SF is, for example, an input interface NF that operates in the same communication standard or protocol as the communication standard or protocol in accordance with which the output interface SF operates.

The generation section 172 then evaluates whether or not an input interface NF of the same type as the type of the output interface SF has been found (step SA5). In a case where no input interface NF of the same type as the type of the output interface SF has been found (NO in step SA5), the controller 170 carries out a corresponding process (SA6). For example, as the corresponding process, the controller 170 notifies the user of information representing that no input interface NF of the same type as the type of the output interface SF has been found.

On the other hand, in a case where an input interface NF of the same type as the type of the output interface SF has been found (YES in step SA5), the generation section 172 generates a selection screen SG containing the input interface NF of the same type as the type of the output interface SF but no input interface NF of a type different from the type of the output interface SF out of the input interfaces NF provided in the input interface unit 151 (step SA7). In the following description, an input interface NF of the same type as the type of the output interface SF is referred to as a same-type interface (first input section), and an input interface NF of a type different from the type of the output interface SF is referred to as a different-type interface (second input section).

The HDMI interfaces 151A and the HDMI interface 71 are of the same type, the first wireless communication interface 151F and the first wireless communication interface 72 are of the same type, and the second wireless communication interface 151G and the second wireless communication interface 73 are of the same type, as described above. The generation section 172 therefore generates a selection screen SG containing the HDMI interfaces 151A, the first wireless communication interface 151F, and the second wireless communication interface 151G but no other input interface NF. The situation in which the selection screen SG contains or does not contain an input interface NF corresponds to a situation in which the selection screen SG contains or does not contain an interface information IJ representing an input interface NF. In the present embodiment, the situation in which the selection screen SG contains information (including interface information IJ) means a situation in which the selection screen SG displays information.

FIG. 6 shows an example of the selection screen SG generated by the generation section 172.

The selection screen SG contains interface information IJ representing the same-type interfaces but no interface information IJ representing different-type interfaces. That is, the selection screen SG contains interface information IJ11 representing the HDMI interfaces 151A, the interface information IJ9 representing the first wireless communication interfaces 151F, and the interface information IJ10 representing the second wireless communication interfaces 151G. The interface information IJ11 is interface information IJ explicitly showing the interface information IJ1, IJ2, and IJ3 in a collective manner. The selection screen SG may instead contain the interface information IJ1, IJ2, and IJ3.

The pieces of interface information IJ contained in the selection screen SG are each contained in the home screen HG selectively by operation performed, for example, on the remote control 5 or the operation panel 131, as in the case of the pieces of interface information IJ contained in the home screen HG. When any one of the pieces of interface information IJ in the selection screen SG is selected, the projection control section 171 sets the interface to which the terminal apparatus 200 has inputted at least a video signal to be the interface indicated by the selected interface information IJ.

The selection screen SG contains the user information RJ in a user recognizable manner. In FIG. 6, the selection screen SG contains user information RJ representing a “user A.”

The selection screen SG further contains a button B1 for causing the selection screen SG to transition to a screen containing the different-type interfaces. The button B1 is configured to be selectable by the user. When the button B1 is selected on the selection screen SG, the projection control section 171 projects a screen containing interface information IJ representing the different-type interfaces on the screen SC.

Referring back to the description of the flowchart FB in FIG. 4, when the generation section 172 generates a selection screen SG, the projection control section 171 projects the selection screen SG on the screen SC (step SA8).

The generation section 172 thus generates a selection screen SG containing interface information IJ representing a same-type interface but no interface information IJ representing a different-type interface. The projection control section 171 then projects the selection screen SG generated by the generation section 172. As described above, since the projector 100 projects a selection screen SG containing a narrowed-down input interface NF, the user can readily determine which input interface NF should be selected when the terminal apparatus 200 is connected to the projector 100. The user's convenience is therefore improved. In particular, the selection screen SG contains an input interface NF connectable to the terminal apparatus 200. The user can therefore readily determine which input interface NF is the input interface NF connectable to the terminal apparatus 200.

In general, in the case of an input interface NF using a wired communication method, the enclosure of the projector 100 is provided with a connector in compliant with the standard associated with the wired communication method. On the other hand, in the case of an input interface NF using a wireless communication method, no connector compliant with the standard associated with the wireless communication method is provided. Therefore, the user can determine whether or not an input interface NF using a wired communication method is provided by visual recognition of the projector 100, but it is difficult in some cases for the user to determine whether or not an input interface NF using a wireless communication method is provided. In contrast, since the generation section 172 generates the selection screen SG described above, the user can readily determine whether or not an input interface NF using a wireless communication method and connectable to the terminal apparatus 200 is provided. Further, since the selection screen SG contains an input interface NF using a different-type wireless communication method as different interface information IJ, the user can readily determine whether or not an input interface NF using a wireless communication method is connectable to the terminal apparatus 200 on an input interface type basis.

The generation section 172 generates a selection screen SG containing the user information RJ. The projection control section 171 then projects the selection screen SG. The user can therefore readily determine that the projected selection screen SG is the selection screen SG associated with the terminal apparatus 200 being used by the user.

The above description has been made of the action of transmitting output interface information representing all output interfaces SF provided in the output interface unit 70 to the projector 100. The output interfaces SF indicated by the output interface information do not need to coincide with all the output interfaces SF provided in the output interface unit 70 and may instead be part thereof. This configuration will be described with reference to a plurality of examples.

### FIRST EXAMPLE

A first example will first be described. In the first example, the description will be made with reference to the flowcharts shown in FIG. 4, but the description of each process in the flowcharts will be omitted or simplified as appropriate.

In the first example, the terminal apparatus 200 is so configured that the user can set an output interface SF that the user desires to use in the connection to the projector 100. For example, the terminal controller 20 of the terminal apparatus 200 displays a user interface for setting the output interface SF on the terminal display section 50 with the aid of a function of the dedicated application SA and accepts the user's setting of the output interface SF that the user decides to use. Specifically, the terminal apparatus 200 detects the user's operation and sets the output interface SF contained in the output interface information based on the detected operation. More specifically, the terminal input section 60 detects the operation of setting the output interface SF that the user desires to use in the connection to the projector 100, generates operation information based on the operation, and outputs the operation information to the terminal controller 20. The output information generation section 22 of the terminal controller 20 then generates output interface information representing the set output interface SF based on the operation information.

In the case where it is determined in step SB1 that the trigger has been issued (YES in step SB1), the output information generation section 22 of the terminal controller 20 generates output interface information representing the output interface SF set by the user (step SB2). For example, in a case where the user has set the HDMI interface 71 as the output interface SF that the user desire to use in the connection to the projector 1, the output information generation section 22 generates output interface information representing only the HDMI interfaces 151A. The communication control section 21 of the terminal controller 20 then transmits the output interface information generated by the output information generation section 22 and the user information RJ to the projector 100.

In the case where it is determined that a same-type interface has been found (YES in step SA5), the generation section 172 of the projector 100 generates a selection screen SG containing interface information IJ representing the same-type interface but no interface information IJ representing different-type interfaces. For example, in the case where the output interface information representing only the HDMI interface 71 has been received, the generation section 172 judges that there is a same-type interface (YES in step SA5) and generates a selection screen SG containing interface information IJ representing the HDMI interface 151A but no other interface information IJ (step SA7). The projection control section 171 then projects the selection screen SG generated by the generation section 172 on the screen SC (step SA8).

As described above, the terminal apparatus 200 is configured to allow the user to set an output interface SF in the output interface information. That is, the terminal apparatus 200 is configured to allow the user to set an output interface SF used in the connection to the projector 100. In the case where the projector 100 includes an input interface NF of the same type as the type of the output interface SF set by the user, the generation section 172 generates a selection screen SG containing interface information IJ representing the output interface SF. The projector 100 can therefore present an input interface NF connectable to the output interface SF set by the user to the user. The user can therefore readily select the input interface NF that the user desires to use from a plurality of input interfaces NF. Further, the user can readily determine whether the projector 100 includes the input interface NF that the user desires to use. The projector 100 can therefore improve the user's convenience when the terminal apparatus 200 is connected to the projector 100.

### SECOND EXAMPLE

A second example will be described. Also in the second example, the description will be made with reference to the flowcharts shown in FIG. 4, but the description of each process in the flowcharts will be omitted or simplified as appropriate.

In the second example, the terminal apparatus 200 sets an output interface SF used at the highest frequency. For example, the terminal controller 20 of the terminal apparatus 200 accumulatively counts the use of each of the output interfaces SF provided in the output interface unit 70 with the aid of a function of the dedicated application SA.

In the case where it is determined in step SB1 that the trigger has been issued (YES in step SB1). the output information generation section 22 of the terminal controller 20 generates output interface information representing only the output interface SF having the largest counts of use as the output interface SF used at the highest frequency (step SB2). For example, in a case where the output interface SF having the largest counts of use is the second wireless communication interface 73, the output information generation section 22 generates output interface information representing only the second wireless communication interface 73. The communication control section 21 of the terminal controller 20 then transmits the output interface information generated by the output information generation section 22 and the user information RJ to the projector 100.

In the case where it is determined that a same-type interface has been found (YES in step SA5), the generation section 172 of the projector 100 generates a selection screen SG containing interface information IJ representing the same-type interface but no interface information IJ representing different-type interfaces. For example, in the case where the output interface information representing only the second wireless communication interface 73 has been received, the generation section 172 generates a selection screen SG containing the interface information IJ10 representing the second wireless communication interface 151G but no other interface information IJ (step SA7). The projection control section 171 then projects the selection screen SG generated by the generation section 172 on the screen SC (step SA8).

As described above, the terminal apparatus 200 is configured to allow an output interface SF used at the highest frequency to be set in the output interface information. In the case where the projector 100 includes an input interface NF of the same type as the type of the output interface SF used at the highest frequency, the generation section 172 generates a selection screen SG containing interface information IJ representing the output interface SF. The projector 100 can therefore present an input interface NF connectable to the output interface SF used at a high frequency to the user. The user can therefore readily select the input interface NF connectable to the output interface SF used at the highest frequency from a plurality of input interfaces NF. Further, the user can readily determine whether the projector 100 includes the input interface NF connectable to the output interface SF used at a high frequency. The projector 100 can therefore improve the user's convenience when the terminal apparatus 200 is connected to the projector 100.

An output interface SF having the largest total counts of use is presented by way of example as an output interface SF used at the highest frequency. The output interface SF used at the highest frequency may instead be an output interface SF having the largest counts of use in a predetermined period.

As described above, the projector 100 (display apparatus) includes a plurality of input interfaces NF (input sections). The projector 100 includes the communication interface section 145 (communication section), the generation section 172, which generates the selection screen SG based on the output interface information (output section information) acquired via the communication interface section 145 and relating to the output interfaces SF (output sections) with which the terminal apparatus 200 (information terminal) is provided, and the projection section 110 (display section), which projects (displays) the selection screen SG. The generation section 172 generates a selection screen SG containing a same-type interface (first input section) but no different-type interface (second input section) based on the output interface information.

According to the configuration described above, since a selection screen SG containing a same-type interface but no different-type interface is generated, the user can readily determine which input interface NF should be selected when the terminal apparatus 200 is connected to the projector 100. The projector 100 can therefore improve the user's convenience when the terminal apparatus 200 is connected to the projector 100.

The generation section 172 generates a selection screen SG containing a same-type interface but no different-type interface with the same-type interface being an input interface NF connectable to an output interface SF and the different-type interface being an input interface NF not connectable to the output interface SF.

According to the configuration described above, the user can readily determine which input interface NF is the input interface NF connectable to the terminal apparatus 200, whereby the user's convenience can be improved when the terminal apparatus 200 is connected to the projector 100.

The terminal apparatus 200 is configured to allow the user to set an output interface SF in the output interface information. In a case where the projector 100 includes an input interface NF connectable to the output interface SF set in the output interface information, the generation section 172 generates the selection screen SG showing the input interface NF as a same-type interface.

According to the configuration described above, the projector 100 can present an input interface NF connectable to an output interface set by the user to the user. The user can therefore readily select the input interface NF that the user desires to use from a plurality of input interfaces NF. Further, the user can readily determine whether the projector 100 includes the input interface NF that the user desires to use. The projector 100 can therefore improve the user's convenience when the terminal apparatus 200 is connected to the projector 100.

The terminal apparatus 200 is configured to allow an output interface SF used at the highest frequency to be set in the output interface information. In the case where the projector 100 includes an input interface NF connectable to the output interface SF set in the output interface information, the generation section 172 generates a selection screen SG showing the input interface NF as a same-type interface.

According to the configuration described above, the projector 100 can present an input interface NF connectable to the output interface SF used at a high frequency to the user. The user can therefore readily select the input interface NF connectable to the output interface SF used at the highest frequency from a plurality of input interfaces NF. Further, the user can readily determine whether the projector 100 includes the input interface NF connectable to the output interface SF used at a high frequency. The projector 100 can therefore improve the user's convenience when the terminal apparatus 200 is connected to the projector 100.

The communication interface section 145 acquires the user information RJ along with the output interface information. The generation section 172 then generates a selection screen SG containing the user information RJ. The user can therefore readily determine that the projected selection screen SG is the selection screen SG associated with the terminal apparatus 200 being used by the user.

### Second Embodiment

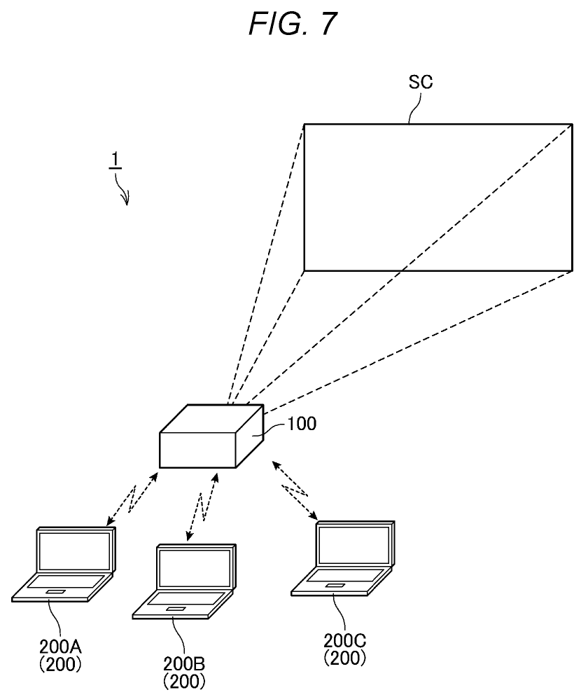

FIG. 7 shows a schematic configuration of an image projection system 1 according to a second embodiment.

In the description with reference to FIG. 7, components similar to the components of the image projection system 1 shown in FIG. 1 have the same reference characters and will not be described in detail.

As apparent from the comparison of FIG. 7 with FIG. 1, in the image projection system 1 according to the second embodiment, one projector 100 communicates with a plurality of terminal apparatuses 200. In FIG. 7, terminal apparatuses 200A, 200B, and 200C communicate with the projector 100. FIG. 7 shows a communication aspect in which the terminal apparatuses 200A, 200B, and 200C each communicate with the projector 100 and the projector 100 displays the selection screen SG as described above.

In the following description, in a case where the terminal apparatuses 200A, 200B, and 200C are not distinguished from one another but are collectively called, the terminal apparatuses 200A, 200B, and 200C are referred to as terminal apparatuses 200. Further, in the following description, a user of the terminal apparatus 200A is called a “user A,” a user of the terminal apparatus 200B is called a “user B,” and a user of the terminal apparatus 200C is called a “user C.”

In the second embodiment, the configurations of the projector 100 and the terminal apparatuses 200 are the same as those in the first embodiment and will therefore not be described in detail.

The projector 100 performs the following actions when the projector 100 communicates with the plurality of terminal apparatuses 200 and projects the selection screen SG, as shown in FIG. 7.

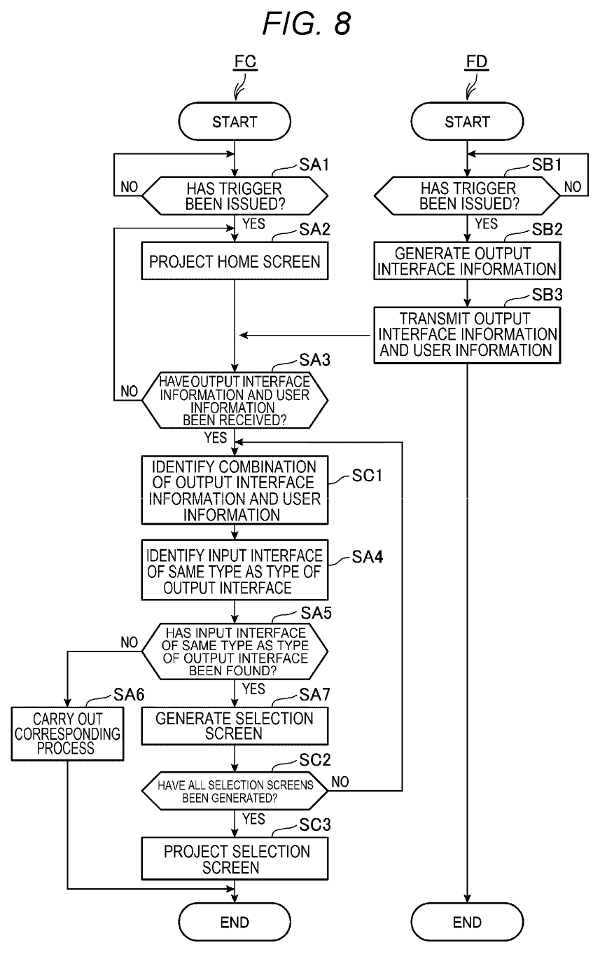

FIG. 8 is flowcharts showing the actions of the projector 100 and the terminal apparatuses 200 according to the second embodiment. In FIG. 8, the flowchart FC shows the action of the projector 100. In FIG. 8, the flowchart FD shows the action of the terminal apparatuses 200.

In the flowchart FC in FIG. 8, the same steps as those in the flowchart FA in FIG. 4 have the same step numbers, and the processes in the same steps will not be described in detail. Similarly, in the flowchart FD in FIG. 8, the same steps as those in the flowchart FB in FIG. 4 have the same step numbers, and the processes in the same steps will not be described in detail.

In the description with reference to FIG. 8, it is assumed that the projector 100 receives the output interface information and the user information RJ from the plurality of terminal apparatuses 200.

When it is determined that the communication interface section 145 has received the output interface information and the user information RJ from the terminal apparatuses 200 (YES in step SA3), the generation section 172 of the controller 170 of the projector 100 carries out the process in step SC1. When the projector 100 receives the output interface information and the user information RJ from the plurality of terminal apparatuses 200, the projector 100 causes the storage 160 or any other component to store the combination of the output interface information and the user information RJ for each of the terminal apparatuses 200.

The generation section 172 then identifies, from the plurality of combinations of the output interface information and the user information RJ, a combination on which the processes in steps SA4 to SA7 are carried out (step SC1). The generation section 172 then carries out the processes in steps SA4 to SA7 based on the combination identified in step SC1 to generate the selection screen SG. For example, in a case where the combination identified in step SC1 is the combination of the information received from the terminal apparatus 200A, the generation section 172 generates a selection screen SG associated with the terminal apparatus 200A and the projector 100.

Having generated the selection screen SG based on the combination identified in step SC1 (step SA7), the generation section 172 evaluates whether or not it has generated the selection screen SG for all the combinations of the output interface information and the user information RJ (step SC2). For example, in a case where the selection screen SG has been generated based on the output interface information and the user information RJ received from the terminal apparatus 200A but no selection screen SG has been generated for the other terminal apparatuses 200, the result of the evaluation performed by the generation section 172 is negative. The generation section 172 then returns to the process in step SC1 and generates the selection screen SG based on the combination of the output interface information and the user information RJ received from the terminal apparatus 200B or 200C. The generation section 172 thus generates the selection screen SG for each of the terminal apparatuses 200.

In a case where the generation section 172 determines that it has generated the selection screen SG for all the combinations of the output interface information and the user information RJ (YES in step SC2), the selection screen SG generated for each of the terminal apparatuses 200 is projected (step SC3). FIG. 9 shows an aspect of the projection.

FIG. 9 shows an example of the selection screen SG. In particular, FIG. 9 shows an example of the selection screen SG in the case where the output interface information and the user information RJ have been received from the plurality of terminal apparatuses 200.

The selection screen SG shown in FIG. 9 contains interface information IJ representing same-type interfaces but no interface information IJ representing different-type interfaces. The selection screen SG shown in FIG. 9 contains the interface information IJ11 representing the HDMI interfaces 151A, the interface information IJ9 representing the first wireless communication interface 151F, and the interface information IJ10 representing the second wireless communication interface 151G. The selection screen SG in FIG. 9 contains the user information RJ representing the “user A.”

Therefore, in a case where the terminal apparatus 200A used by the user A is connected to the projector 100, the selection screen SG shows that the connectable input interface NF is any of the HDMI interfaces 151A, the first wireless communication interface 151F, and the second wireless communication interface 151G.

The selection screen SG contains buttons B2 and B3 located on opposite sides of the user information RJ. The buttons B2 and B3 are buttons for switching the selection screens SG generated in association with the terminal apparatuses 200 from one to another, and the buttons B2 and B3 are each configured to be selectable.

For example, in a case where the button B2 is selected on the selection screen SG in FIG. 9, the projection control section 171 projects the selection screen SG associated with the terminal apparatus 200C. The selection screen SG associated with the terminal apparatus 200C contains the user information RJ representing the “user C” and the interface information IJ representing input interfaces NF to which the terminal apparatus 200C is connectable when the terminal apparatus 200C is connected to the projector 100, as in the selection screen SG in FIG. 9.

For example, in a case where the button B3 is selected on the selection screen SG in FIG. 9, the projection control section 171 projects the selection screen SG associated with the terminal apparatus 200B. The selection screen SG associated with the terminal apparatus 200B contains the user information RJ representing the “user B” and the interface information IJ representing input interfaces NF to which the terminal apparatus 200B is connectable when the terminal apparatus 200B is connected to the projector 100, as in the selection screen SG in FIG. 9.

As described above, in the second embodiment, when the output interface information and the user information RJ are received from the plurality of terminal apparatuses 200, the generation section 172 generates the selection screen SG for each of the terminal apparatuses 200. The projection control section 171 then projects the generated selection screens SG. Therefore, even in the case where there are a plurality of terminal apparatuses 200 to be connected to the projector 100, the user can readily determine which input interface NF should be selected for each of the terminal apparatuses 200. The projector 100 can therefore improve the user's convenience when the plurality of terminal apparatuses 200 are connected to the projector 100.

The aspect in which the selection screen SG generated for each of the terminal apparatuses 200 is projected is not limited to the aspect in which the selection screens SG are switched from one to another when the user selects the button B2 or B3 and may instead be an aspect in which the selection screens SG are switched from one to another when a predetermined period elapses.

### Variation

A variation of the second embodiment will next be described.

In the second embodiment, the generation section 172 generates the selection screen SG for each of the terminal apparatuses 200 by way of example. In the variation, the generation section 172 does not generate the selection screen SG for each of the terminal apparatuses 200 but generates a common selection screen SG.

The variation will be described in detail. The generation section 172 of the controller 170 of the projector 100 receives the output interface information and the user information RJ from the plurality of terminal apparatuses 200 via the communication interface section 145. Having received the output interface information and the user information RJ from the plurality of terminal apparatuses 200, the generation section 172 identifies an output interface SF of a type the number of which is the largest out of the output interfaces SF indicated by the plurality of pieces of output interface information. In a case where the projector 100 includes an input interface NF of the same type as the type of the output interface SF the number of which is the largest, the generation section 172 generates a selection screen SG containing only interface information IJ representing this input interface NF but no other interface information IJ. The projection control section 171 then projects the selection screen SG via the projection section 110.

The generation section 172 generates a selection screen SG containing an output interface SF of a type the number of which is the largest, as described above. In the case where a plurality of terminal apparatuses 200 are connected to the projector 100, the projector 100 can therefore present an input interface NF to which the largest number of terminal apparatuses 200 is connectable to the user. The user can therefore readily determine which input interface NF is the input interface NF to which the largest number of terminal apparatuses 200 is connectable. The projector 100 can therefore improve the user's convenience when the plurality of terminal apparatuses 200 are connected to the projector 100.

The embodiments and variation described above are each a preferable embodiment of the invention. The invention is, however, not limited thereto, and a variety of embodiments are conceivable to the extent that they do not depart from the substance of the invention.

For example, in the embodiments and variation described above, the ten input interfaces NF shown in FIG. 2 are presented by way of example as the interfaces NF provided in the input interface unit 151. The input interfaces NF with which the projector 100 is provided are not limited to the ten input interfaces NF, and the number of the input interfaces NF may be greater than or fewer than ten. This also holds true for the output interfaces SF with which the terminal apparatus 200 is provided.

Further, for example, the above-mentioned embodiments have been described with reference to the case where the projector 100 is a liquid crystal projector using transmissive liquid crystal panels. The projector 100 may instead be a projector using reflective liquid crystal panels or digital mirror devices.

Further, for example, in the case where the method for controlling the projector 100 described above (method for controlling display apparatus) is achieved by using a computer provided in the projector 100 or an external apparatus connected to the projector 100, the invention may be configured in the form of a program executed by the computer to achieve the method, a recording medium on which the program is so recorded as to be readable by the computer, or a transmission medium that transmits the program. The recording medium described above can be a magnetic recording medium, an optical recording medium, or a semiconductor memory device. Specific examples of the recording medium may include a flexible disk, an HDD (hard disk drive), a CD-ROM (compact disk read only memory), a DVD (digital versatile disk), a Blu-ray (registered trademark) disc, a magneto-optical disk, a flash memory, a portable recording medium, such as a card-shaped recording medium, or an immobile recording medium. The recording medium described above may instead be a RAM (random access memory), a ROM (read only memory), or an HDD or any other nonvolatile storage device that is an internal storage device provided in the projector 100 or the external apparatus connected to the projector 100.

The process units in the flowcharts shown in FIGS. 4 and 8 are process units divided in accordance with the contents of the primary processes for easy understanding of the processes carried out by the controller 170 of the projector 100 and the terminal controller 20 of the terminal apparatus 200. How to produce the divided process units or the names of the process units do not limit the embodiments of the invention. The processes carried out by the controller 170 and the terminal controller 20 can each be further divided into a larger number of process units in accordance with the content of the process, and each of the process units can further be divided into a large number of processes. Further, the orders in which the processes are carried out in the flowcharts described above are not limited to those shown in FIGS. 4 and 8.

The functional portions of the projector 100 shown in FIG. 2 and the functional portions of the terminal apparatus 200 shown in FIG. 3 each represent a functional configuration achieved by cooperation between hardware and software and is not necessarily implemented in a specific form. Therefore, hardware corresponding to each of the functional portions is not necessarily implemented, and a single processor that executes a program can, of course, achieve the functions of the plurality of functional portions. Further, part of the functions achieved by software in the embodiments described above may be achieved by hardware, or part of the functions achieved by hardware may be achieved by software.

The display apparatus according to an aspect of the invention is not limited to a projector that projects an image on the screen SC. For example, a variety of other display apparatuses which fall within the scope of the invention are as follows: a liquid crystal monitor or a liquid crystal television that displays an image on a liquid crystal display panel; or a self-luminous display apparatus, such as a monitor apparatus or a television receiver that displays an image on a PDP (plasma display panel) and a monitor apparatus or a television receiver that displays an image on an organic EL display panel called, for example, OLED (organic light-emitting diode) and OEL (organic electro-luminescence).

What is claimed is:

1. A display apparatus including a plurality of input sections including a first input section and a second input section different from the first input section, the display apparatus comprising:
a communication section;
a generation section that generates a selection screen based on output section information acquired via the communication section and relating to an output section with which an information terminal is provided; and
a display section that displays the selection screen,
wherein the generation section generates based on the output section information the selection screen that contains the first input section but does not contain the second input section.

2. The display apparatus according to claim 1,
wherein the generation section generates the selection screen with the first input section being any of the input sections connectable to the output section and the second input section being any of the input sections not connectable to the output section.

3. The display apparatus according to claim 1,
wherein in a case where the information terminal sets the output section indicated by the output section information based on operation detected by the information terminal and any of the input sections of the display apparatus is connectable to the output section set by the information terminal based on the operation, the generation section generates the selection screen with the first input section being the input section.

4. The display apparatus according to claim 1,
Wherein the information terminal is provided with a plurality of the output sections; and
in a case where the information terminal generates the output section information representing the output section used at a largest frequency and any of the input sections of display apparatus is connectable to the output section indicated by the output section information, the generation section generates the selection screen with the first input section being the input section.

5. The display apparatus according to claim 1,
wherein in a case where the output section information is acquired from a plurality of the information terminals via the communication section, the generation section generates the selection screen for each of the information terminals.

6. The display apparatus according to claim 1,
wherein the communication section acquires user information representing a user of the information terminal along with the output section information, and
the generation section generates the selection screen containing the user information.

7. A method for controlling a display apparatus including a plurality of input sections including a first input section and a second input section different from the first input section, the method comprising:
acquiring output section information on an output section with which an information terminal is provided;
generating based on the acquired output section information a selection screen that contains the first input section but does not contain the second input section; and
displaying the selection screen.

8. The method for controlling a display apparatus according to claim 7,
wherein the selection screen is generated with the first input section being any of the input sections connectable to the output section and the second input section being any of the input sections not connectable to the output section.

9. The method for controlling a display apparatus according to claim 7,
wherein in the information terminal is provided with a plurality of the output sections; and
a case where the information terminal sets the output section indicated by the output section information based on operation detected by the information terminal and any of the input sections of the display apparatus is connectable to the output section set based on the operation, the selection screen is generated with the first input section being the input section.

10. The method for controlling a display apparatus according to claim 7,
wherein in a case where the information terminal generates the output section information representing the output section used at a largest frequency and any of the input sections of display apparatus is connectable to the output section indicated by the output section information, the selection screen is generated with the first input section being the input section.

11. The method for controlling a display apparatus according to claim 7,
wherein in a case where the output section information is acquired from a plurality of the information terminals via the communication section, the selection screen is generated for each of the information terminals.

12. The method for controlling a display apparatus according to claim 7,
wherein user information representing a user of the information terminal is acquired along with the output section information, and
the selection screen containing the user information is generated.
